(19) United States
(12) Patent Application Publication
(10) Pub. No.: US 2014/0124496 A1
(43) Pub. Date: May 8, 2014

(54) SYSTEMS AND METHODS USING A GLASSY CARBON HEATER

(71) Applicant: The Trustees of Columbia University in the City of New York, (US)

(72) Inventors: Jorge Manuel Garcia Martinez, Summit, NJ (US); Aron Pinczuk, Westfield, NJ (US)

(73) Assignee: The Trustees of Columbia University in the City of New York, New York, NY (US)

(21) Appl. No.: 13/801,689

(22) Filed: Mar. 13, 2013

Related U.S. Application Data
(63) Continuation of application No. PCT/US1011/053954, filed on Sep. 29, 2011.

(51) Int. Cl. H05B 3/02

(52) U.S. Cl. CPC H05B 3/02
USPC 219/438

(57) ABSTRACT

Systems and methods for heating a material wherein the system includes an electrical contact adapted to receive current and a glassy carbon heater in electrical communication with the electrical contact. In one embodiment, the sample is thermally evaporated. In one embodiment, a holding element adapted to hold the material, located in such proximity to the glassy carbon heater so as to receive heat generated by the glassy carbon heater, is included.

### PRIORITY CLAIM

This application is a continuation of International Application No. PCT/US2011/053954, filed Sep. 29, 2011, which claims the benefit of U.S. Provisional Patent Application No. 61/387,791, filed Sep. 29, 2010, which is hereby incorporated by reference in its entirety.

### GRANT INFORMATION

This invention was made with government support under U.S. Office of Naval Research Grant No. N00014-06-10138 awarded by the U.S. Office of Naval Research, Grant No. UMARY Z894102 awarded by the U.S. Office of Naval Research—Multi-University Research Initiative, and Grant No. CHE-06-41523 awarded by the U.S. National Science Foundation—NSEC Initiative. The U.S. government has certain rights in the invention.

This invention was also made with the support of the Spanish National Research Council (CSIC) under Spanish grants: Q&C Light (S2009ESP-1503), Numancia 2 (S2009/ENE-1477)), MICINN (NANINPHO-QD, TEC2008-06756-C03-01, Consolider QOIT (CSD2006-0019), Consolider GENESIS MEC (CSD2006-0004) and Salvador de Madariaga Grant no. PR2007-0036). The Spanish government has certain rights in the invention.

### INTRODUCTION

The presently disclosed subject matter relates to systems and methods for using glassy carbon as a heating element. The presently disclosed subject matter also relates to systems and methods for enhanced thermal evaporation of a material.

### BACKGROUND

There are several known methods for the construction of high-temperature vacuum furnaces using refractory materials as heating elements, which are made out of high melting point materials such as graphite, iron, molybdenum, tantalum, and/or tungsten.

There are also several known systems and methods for the deposition of materials in vacuum. Some achieve evaporation by annealing the materials until the vapor pressure is high enough to produce a beam of material. Examples of typical elements to be evaporated and elements used as supporting materials are shown in Table 1 below.

TABLE 1
Typical evaporation temperatures and vapor pressures of several
materials usually employed in evaporation processes in vacuum

| | Material to be evaporated | | | | | | | | Supporting material | | | |
|---|---|---|---|---|---|---|---|---|---|---|---|---|
| | Zn | Al | Ge | Cu | Au | Ti | Ni | Pt | Mo | Carbon | Ta | W |
| T (C.) at which | 150 | 730 | 870 | 800 | 847 | 1180 | 967 | 1400 | 1600 | 1800 | 2100 | 2230 |
| Vapor Pressure = | | | | | | | | | | | | |
| 1 × 10e−7 | | | | | | | | | | | | |
| (mmHg) (1) | | | | | | | | | | | | |
| T (C.) for growth | 230 | 930 | 967 | 1030 | 1120 | 1227 | 1230 | 1660 | 2080 | 2330 | 2560 | 2730 |
| rate 1 μg/cm² sec | | | | | | | | | | | | |
| (2) | | | | | | | | | | | | |
| Growth rate at | >10¹⁰ | 10⁵ | 10⁷ | 10⁷ | 10⁶ | 10^{5.5} | 10^{6.5} | 10⁴ | 10^{2.5} | 1 | 1⁻² | 10⁻² |
| 1230 C. | | | | | | | | | | | | |
| (10⁻⁷ g/cm²sec) | | | | | | | | | | | | |
| (2) | | | | | | | | | | | | |

One evaporation method is thermal evaporation, which uses a small metal container that is annealed by the Joule effect by driving a high-ampere current through the container. The metal container can be made of molybdenum, tantalum, or tungsten. The metal container acts both as a heater and as a crucible for holding the pure elements to be evaporated. The power required to achieve evaporation can be from about 100 W to about 600 W. Due to the fact that the heating element is a metal with a low resistivity, the currents required for this method are typically around the hundreds of amperes (e.g., 100-300 A). The use of large currents often leads to heavy-duty vacuum feed-throughs, large power supplies, and expensive and complicated cooling technology to maintain a suitable vacuum level.

Another method for vacuum deposition is electron beam (e-beam) bombardment annealing. Compared to thermal evaporation, e-beam bombardment uses small currents, on the order of 10 mA, that are accelerated to 10 kV and impinge onto the target, delivering the annealing power. E-beam bombardment annealing, like thermal evaporation, uses power levels that can be about 200W. Thus, to achieve the required power with small currents, a high voltage is applied, leading to more complex systems for electrical isolation, electronic power supply and security management.

### SUMMARY

One aspect of the presently disclosed subject matter provides systems and methods utilizing glassy carbon as a heating element.

In one embodiment, the disclosed subject matter includes a system for heating (annealing) a sample comprising an electrical contact adapted to receive current, a glassy carbon heater in electrical communication with the electrical contact, and a sample located in such proximity to the glassy carbon heater so as to receive the heat generated by the glassy carbon heater.

In another embodiment, the disclosed subject matter includes a method for heating a sample comprising providing an electrical contact adapted to receive current; a glassy carbon heater in electrical communication with the electrical contact; a sample located in such proximity to the glassy carbon heater so as to receive heat generated by the glassy carbon heater to heat the sample; and applying current to the electrical contact.

Another aspect of the presently disclosed subject matter provides systems and methods for enhanced thermal evaporation (“ETE”) of a sample. In these embodiments, the glassy carbon heater is heated to a temperature sufficient to evaporate the sample.

In one embodiment, the systems and methods of the present disclosure include a holding element, e.g., a container, fastener, or clamps, or other appropriate holding element, adapted to hold the sample, the holding element located in such proximity to the glassy carbon heater so as to allow the sample to receive heat generated by the glassy carbon heater.

In particular embodiments, the systems of the present disclosure further comprise a vacuum source. In an alternate embodiment, the systems of the present disclosure are operated in an inert gas environment.

In certain embodiments, the glassy carbon heater is heated to a temperature sufficient to heat or evaporate the sample. In one embodiment, the glassy carbon heater is heated to a temperature of from about 20° C. to about 800° C. In certain embodiments, the glassy carbon heater is heated from about 800° C. to about 1,800° C.

In certain embodiments, the current applied to the electrical contact is less than about 100 A. In particular embodiments, the current applied to the electrical contact is less than about 25 A.

In certain embodiments, the a pressure of less than about 10⁻³ torr is provided.

In certain embodiments, the sample to be heated or evaporated can be any material commonly employed in known thermal heating systems or evaporation systems, such as e-beam bombardment annealing or other thermal evaporation systems. For example, in some embodiments, the sample is selected from zinc, aluminum, germanium, copper, silver, gold, titanium, nickel, platinum, palladium, lithium, beryllium, sodium, magnesium, potassium, calcium, rubidium, strontium, cesium, barium, scandium, yttrium, lanthanum, vanadium, cadmium, mercury, boron, gallium, indium, thallium, silicon, germanium, tin, lead, bismuth, antimony, arsenic, selenium, iron, cobalt, chromium, manganese, lutetium, ytterbium, erbium, dysprosium, europium, cerium, AlF₃, AlN, AlSb, AlAs, AlBr₃, Al₄C₃, A₂Cu, AlF₃, AlN, Al₂Si, Sb₂Te₃, Sb₂O₃, Sb₂Se₃, Sb₂S3, As₂Se₃, As₂S₃, As₂Te₃, BaCl₂, BaF₂, BaO, BaTiO₃, BeCl₂, BeF₂, BiF₃, Bi₂O₃, Bi₂Se₃, Bi₂Te₃, Bi₂Ti₂O₇, Bi₂S3, B₂O₃, B₂S3, CdSb, Cd₃As₂, CdBr₂, CdCl₂, CdF₂, CdI₂, CdO, CdSe, CdSiO₂, CdS, CdTe, CaF₂, CaO, CaO—SiO₂, CaS, CaTiO₃, CeF₃, CsBr, CsCl, CsF, CsOH, CsI, NasAl₃F₄, CrBr₂, CrCl₂, Cr—SiO, CoBr₂, CoCl₂, CuCl, Cu₂O, CuS, Na₃AlF₆, DyF₃, ErF₃, EuF₂, EuS, GaSb, GaAs, GaN, GaP, Ge₃N₂, GeO₂, GeTe, HoF₃, InSb, InAs, In₂O₃, InP, In₂Se₃, In₂S₃, In₂S, In₂Te₃, In₂O₃—SnO₂, FeCl₂, FeI₂, FeO, Fe₂O₃, FeS, FeCrAl, LaBr₃, LaF₃, PbBr₂, PbCl₂, PbFz, PbI₂, PbO, PbSnO₃, PbSe, PbS, PbTe, PbTiO₃, LiBr, LiCl, LiF, LiI, Li₂O, MgBr₂, MgCl₂, MgF₂, MgI₂, MnBr₂, MnCl₂, Mn₃—O₄, MnS, HgS, MoS₂, MoO₃, NdF₃, Nd₂O₃, NiBr₂, NiCl₂, NiO, NbB₂, NbC, NbN, NbO, Nb₂O₅, NbTex, Nb₃Sn, PdO, C₅H₈, KBr, KCl, KF, KOH, KI, Re₂O₇, RbCl, RbI, SiB₆, SiO₂, SiO, Si₃N₄, SiSe, SiS, SiTe₂, AgBr, AgCl, AgI, AgI, NaBr, NaCl, NaCN, NaF, NaOH, MgO₃, SrF₂, S₈, TaS₂, PTFE, TbF₃, Tb₄O₇, TlBr, TlCl, TlI, Tl₂O₃, ThBr₄, ThF₄, ThOF₂, ThS₂, Tm₂O₃, SnO₂, SnSe, SnS, SnTe, TiO₂, WTe₃, WO₃, UF₄, U₃O₈, UP₂, U₂S₃, V₂O₅, VSi₂, YbF₃Yb₂O₃, YF₃, Zn₃Sb₂, ZnBr₂, ZnF₂, Zn₃N₂, ZnSe, and ZrSi₂.

In particular embodiments, the holding element holding the sample is made of a refractory material, e.g., any material that retains its strength at high temperatures, commonly with melting temperatures above 2000° C. In specific embodiments, the refractory material is selected from tantalum, molybdenum, tungsten, tungsten carbide, rhenium, ruthenium, iridium, osmium, hafnium, zirconium, zirconium dioxide, niobium, vanadium, chromium, beryllium oxide, glassy carbon, aluminum oxide, boron nitride, oxide, quartz, sapphire, titanium, titanium-carbide, thorium dioxide, and ceramic, hafnium carbide, and tantalum hafnium carbide. The holding element can be any shape suited to hold the sample. In particular embodiments, the holding element is a container that is circular, oval, rectangular, square, triangular, elliptical, polygonal shape, or bowl-shaped. In other embodiments, the holding element is a fastener or clamp to hold the sample in place.

In some embodiments, the glassy carbon heater has a thickness of from, for example, about 100 μm to about 1 cm. In particular embodiments, the glassy carbon heater is adapted to engage with at least two electrical contacts at or near two ends of the glassy carbon heater. In one embodiment, the glassy carbon heater is provided with apertures and engaged with the at least two electrical contacts via a metal screw and a washer.

In some embodiments, the method further comprises providing a substrate in proximity to a sample to be evaporated, e.g., in any orientation that allows for the sample to be deposited onto the substrate during evaporation. In particular embodiments, the substrate is a dielectric substrate. Non-limiting examples of dielectric substrates include glass, sapphire, mica, silicon dioxide, silicon nitride, silicon oxy-nitride, aluminum oxide, silicon carbide nitride, organo-silicate glass, carbon-doped silicon oxides, and methylsilsesquioxane (MSQ). In one embodiment, the substrate is a semiconducting substrate. Non-limiting examples of semiconducting substrates include silicon, such as silicon carbide, zinc selenide, gallium arsenide, gallium nitride, cadmium telluride and mercury cadmium telluride.

### BRIEF DESCRIPTION OF THE FIGURES

FIG. 1 shows a picture of one embodiment of an exemplary heating system utilizing a glassy carbon heater according to the disclosed subject matter.

FIG. 2 shows the back view of the heating system of Example 2.

FIG. 3 shows the front view of the heating system of Example 2.

FIG. 4 shows a schematic diagram of an exemplary embodiment of a system for enhanced thermal evaporation according to the disclosed subject matter.

FIG. 5 shows one embodiment of the glassy carbon heater of FIG. 4.

FIG. 6 shows some unassembled components of one embodiment of the system of FIG. 4 before the evaporation process.

FIG. 7 shows one embodiment of the components of FIG. 6 after the evaporation process.

FIG. 8 shows a schematic diagram of another embodiment of a system for evaporation according to the disclosed subject matter.

### DETAILED DESCRIPTION

In one aspect, the presently disclosed subject matter provides methods and systems for heating (annealing) a sample utilizing glassy carbon as the heating element. In one embodiment, the sample is thermally evaporated by the heat generated from the glassy carbon heater. The sample is placed in proximity to the glassy carbon heater so as to receive the heat generated by the glassy carbon heater. In one embodiment, the sample is held by a holding element. In another embodiment, the sample is held in place using, for example, a container, fasteners or clamps. In some embodiments, the sample is heated in a vacuum. In other embodiments, the sample is heated in an inert gas environment.

In one embodiment, the glassy carbon heater used in the methods of systems of the disclosure has a resistivity of ten times or more than that of metals used in other heating or thermal evaporation methods. In one embodiment, the glassy carbon heater has a resistivity of about 0.1 Ohm to about 0.6 Ohm. Hence, for example, the necessary power for evaporation of a sample, which is around the order of 100-300 W, can be produced using greatly reduced currents as compared to those required for other thermal evaporation methods. Accordingly, the systems and methods for heating or thermal evaporation can be implemented using relatively inexpensive electronics, operating at currents of about 20 A or less and between about 3 to 4 volts. Moreover, due to the smaller currents and moderate voltages required, the required power can be achieved with a reduced investment in refrigeration, high-voltage power supplies, and security management protocols. These current and volt values are exemplary.

Furthermore, by separating the heating element from the element that holds the sample (e.g., the container, fastener, or clamp, or other element used to hold a sample in place), a wider range of materials can be used for the holding element since this element does not need to be made of a conducting material. The holding element only needs to be made of a highly temperature stable material that does not significantly react with the sample to be evaporated. In addition, the holding element does not need to be permanently attached to the system. This enables the holding element to be easily replaceable and interchangeable with other holding elements.

As used herein, the term “growth” refers to a process in which a material is deposited on the surface of another material.

As used herein, the term “High Vacuum” or “HV” refers to a vacuum at a pressure of about 1×10⁻⁶ to about 1×10⁻⁸ Torr.

As used herein, the term “Ultra High Vacuum” or “UHV” refers to a vacuum at a pressure of in the range from 1×10⁻⁹ Torr to 1×10⁻¹⁰ Torr.

As used herein, the term “deep Ultra High Vacuum” or “deep UHV” refers to a vacuum at a pressure of less than about 1×10⁻¹⁰ Torr.

As used herein, the term “refractory material” refers to a material that is stable at a temperature higher than about 1000° C.

### Glassy Carbon Heater

As used herein, the term “glassy carbon” or “vitreous carbon” refers to agranular non-graphitizable carbon with a very high isotropy of its structural and physical properties and with a very low permeability for liquids and gases. Glassy carbon is an advanced material of pure carbon combining glassy and ceramic properties with these of graphite. Unlike graphite, glassy carbon has a fullerene-related microstructure. This leads to a great variety of unique material properties. As used herein, the term “glassy carbon heater” refers to glassy carbon that is used to radiate heat.

In particular embodiments, the presently disclosed subject matter includes systems and methods for heating or evaporating a sample comprising a glassy carbon heater and a sample, the sample located in such proximity to the glassy carbon heater so as to receive the heat generated by the glassy carbon heater.

There is no limitation on the size of the glassy carbon heater. For example, larger filaments will require larger currents and need to be appropriately scaled to withstand the weight of the sample material to be evaporated.

The glassy carbon heater can be any shape. In particular embodiments, the glassy carbon heater is laser-cut into a particular shape. In certain embodiments, the glassy carbon heater is in the shape of a plate. The glassy carbon material for the glassy carbon heater can be purchased in the shape of plates directly from a supplier, such as HTW Hochtemperature-Werkstoffe GmbH (Thierhaupten, Germany). In one non-limiting embodiment, the glassy carbon plate can be laser-cut by Accu-Tech (550 S. Pacific Street Suite A100, San Marcos, Calif. 92078). In specific embodiments, the glassy carbon heater is “dog-bone” shaped.

In particular embodiments, the ring-shaped ends of the glassy carbon heater are connected by an integrally-formed metal strip. In one embodiment, one or more concavities are formed where the ring-shaped end connects with the thin strip. In particular embodiments, electrical contacts can be inserted through the one or more concavities in the ring-shaped end of the glassy carbon heater. In certain embodiments, the glassy carbon heater is adapted to engage with at least two electrical contacts at or near two ends of the glassy carbon heater. In one embodiment, the glassy carbon heater is provided with apertures and engaged with at least two electrical contacts via a metal screw and a washer in each side of the glassy carbon heater. In certain embodiments, a washer can be made of rhenium to provide little or no reaction with the glassy carbon heater and another washer can be made of tantalum alloy, such as a tantalum-tungsten alloy, to provide a stable fixture of parts for heating cycles.

The glassy carbon heater can have any dimensions that allow the presently disclosed systems to function properly. In some embodiments, the glassy carbon heater has a thickness of from about 100 μm to about 1 cm. In particular embodiments, the glassy carbon heater has a thickness of from about 300 μm to about 500 μm. In particular embodiments, the glassy carbon heater has a thickness of from about 100 μm to about 300 μm, about 300 μm to about 500 μm, about 500 μm to about 1,500 μm, about 1.5 mm to about 5 mm, about 5 mm to about 1 cm, or about 5 mm to about 20 mm.

### Use of the Glassy Carbon Heater

A particular embodiment of the presently disclosed subject matter provides systems and methods for heating a sample or for enhanced thermal evaporation of a sample comprising an electrical contact adapted to receive current; a glassy carbon heater in electrical communication with the electrical contact; and a sample located in such proximity to the glassy carbon heater so as to receive heat generated by the glassy carbon heater to heat or evaporate the sample.

The electrical contact adapted to receive current and in contact with the glassy carbon heater can be made from any refractory conducting material. Non-limiting examples of conductive refractory materials include tantalum, molybdenum, tungsten, rhenium, niobium and glassy carbon.

Alternatively, the electrical contact materials can comprise discrete sections of two or more conducting materials. The electrical contact materials can be made from any conductive material, provided that the material in direct electrical communication with the glassy carbon heater is made of a refractory material. Non-limiting examples of electrical conductive materials include tantalum, molybdenum, tungsten, niobium, rhenium, glassy carbon, lithium, palladium, platinum, silver, copper, gold, aluminum, zinc, nickel, brass, bronze, iron, platinum, steal, lead, alloys thereof, graphite, and conductive polymers.

The glassy carbon heater is heated to a temperature lower than that required for evaporation of the glassy carbon heater but sufficient to process the sample under particular conditions, e.g., in vacuum or inert gas. In one embodiment, the glassy carbon heater is heated to the temperature necessary for evaporation of the sample material. In one embodiment, the glassy carbon heater is heated to a temperature in a range from room temperature, e.g., about 20° C. to about 1,800° C. In some embodiments, the glassy carbon heater is heated from about 800° C. to about 1,400° C. In certain embodiments, the glassy carbon heater is heated from about 20° C. to about 800° C. Some non-limiting examples of the temperature that the glassy carbon heater is heated to include about 20° C., about 50° C., about 100° C., about 150° C., about 200° C., about 250° C., about 300° C., about 350° C., about 400° C., about 450° C., about 500° C., about 550° C., about 600° C., about 650° C., about 700° C., about 750° C., about 800° C., about 850° C., about 900° C., about 950° C., about 1,000° C., about 1,050° C., about 1,100° C., 1,150° C., about 1,200° C., about 1,250° C., about 1,300° C. 1,350° C., about 1,400° C., 1,450° C., about 1,500° C., about 1,550° C., about 1,600° C., about 1,650° C., about 1,700° C., and about 1,750° C.

There is no limitation on the type of sample that can be heated. Non-limiting examples of samples that can be heated include zinc, aluminum, germanium, copper, silver, gold, titanium, nickel, platinum, palladium, lithium, beryllium, sodium, magnesium, potassium, calcium, rubidium, strontium, cesium, barium, scandium, yttrium, lanthanum, vanadium, cadmium, mercury, boron, gallium, indium, thallium, silicon, germanium, tin, lead, bismuth, antimony, arsenic, selenium, iron, cobalt, chromium, manganese, lutetium, ytterbium, erbium, dysprosium, europium, diamond, sapphire, quartz, and cerium. In certain embodiments, the sample to be heated is selected from an alloy including AlF₃, AlN, AlSb, AlAs, AlBr₃, Al₄C₃, Al₂Cu, AlF₃, AlN, Al₂Si, Sb₂Te₃, Sb₂O₃, Sb₂Se₃, Sb₂S₃, As₂Se₃, As₂S₃, As₂Te₃, BaCl₂, BaF₂, BaO, BaTiO₃, BeCl₂, BeF₂, BiF₃, Bi₂O₃, Bi₂Se₃, Bi₂Te₃, Bi₂Ti₂O₇, Bi₂S3, B₂O₃, B₂S₃, CdSb, Cd₃As₂, CdBr₂, CdCl₂, CdF₂, CdI₂, CdO, CdSe, CdSiO₂, CdS, CdTe, CaF₂, CaO, CaO—SiO₂, CaS, CaTiO₃, CeF₃, CsBr, CsCl, CsF, CsOH, CsI, NasAl₃Fl₄, CrBr₂, CrCl₂, Cr—SiO, CoBr₂, CoCl₂, CuCl, Cu₂O, CuS, Na₃AlF₆, DyF₃, ErF₃, EuF₂, EuS, GaSb, GaAs, GaN, GaP, Ge₃N₂, GeO₂, GeTe, HoF₃, InSb, InAs, In₂O₃, InP, In₂Se₃, In₂S₃, In₂S, In₂Te₃, In₂O₃—SnO₂, FeCl₂, FeI₂, FeO, Fe₂O₃, FeS, FeCrAl, LaBr₃, LaF₃, PbBr₂, PbCl₂, PbF₂, PbI₂, PbO, PbSnO₃, PbSe, PbS, PbTe, PbTiO₃, LiBr, LiCl, LiF, Li, Li₂O, MgBr₂, MgCl₂, MgF₂, MgI₂, MnBr₂, MnCl₂, Mn₃O₄, MnS, HgS, MoS₂, MoO₃, NdF₃, Nd₂O₃, NiBr₂, NiCl₂, NiO, NbB₂, NbC, NbN, NbO, Nb₂O₅, NbTex, Nb₃Sn, PdO, C₈H₈, KBr, KCl, KF, KOH, KI, Re₂O₇, RbCl, RbI, SiB₆, SiO₂, SiO, Si₃N₄, SiSe, SiS, SiTe₂, AgBr, AgCl, AgI, AgI, NaBr, NaCl, NaCN, NaF, NaOH, MgO₃, SrF₂, Ss, TaS₂, PTFE,TbF₃, Tb₄O₇, TlBr, TlCl, TlI, Tl₂O₃, ThBr₄, ThF₄, ThOF₂, ThS₂, Tm₂O₃, SnO₂, SnSe, SnS, SnTe, TiO₂, WTe₃, WO₃, UF₄, U₃O₈, UP₂, U₂S₃, V₂O₅, VSi₂, YbF₃Yb₂O₃, YF₃, Zn₃Sb₂, ZnBr₂, ZnF₂, Zn₃N₂, ZnSe, and ZrSi₂.

In one embodiment, the sample is evaporated. Non-limiting examples of samples that can be evaporated include zinc, aluminum, germanium, copper, silver, gold, titanium, nickel, platinum, palladium, lithium, beryllium, sodium, magnesium, potassium, calcium, rubidium, strontium, cesium, barium, scandium, yttrium, lanthanum, vanadium, cadmium, mercury, boron, gallium, indium, thallium, silicon, germanium, tin, lead, bismuth, antimony, arsenic, selenium, iron, cobalt, chromium, manganese, lutetium, ytterbium, erbium, dysprosium, europium, and cerium. In certain embodiments, the sample to be evaporated is selected from an alloy including AlF₃, AlN, AlSb, AlAs, AlBr₃, Al₄C₃, Al₂Cu, AlF₃, AlN, Al₂Si, Sb₂Te₃, Sb₂O₃, Sb₂Se₃, Sb₂S₃, As₂Se₃, As₂S₃, As₂Te₃, BaCl₂, BaF₂, BaO, BaTiO₃, BeCl₂, BeF₂, BiF₃, Bi₂O₃, Bi₂Se₃, Bi₂Te₃, Bi₂Ti₂O₇, Bi₂S3, B₂O₃, B₂S₃, CdSb, Cd₃As₂, CdBr₂, CdCl₂, CdF₂, CdI₂, CdO, CdSe, CdSiO₂, CdS, CdTe, CaF₂, CaO, CaO—SiO₂, CaS, CaTiO₃, CeF₃, CsBr, CsCl, CsF, CsOH, CsI, NasAl₃Fl₄, CrBr₂, CrCl₂, Cr—SiO, CoBr₂, CoCl₂, CuCl, Cu₂O, CuS, Na₃AlF₆, DyF₃, ErF₃, EuF₂, EuS, GaSb, GaAs, GaN, GaP, Ge₃N₂, GeO₂, GeTe, HoF₃, InSb, InAs, In₂O₃, InP, In₂Se₃, In₂S₃, In₂S, In₂Te₃, In₂O₃—SnO₂, FeCl₂, FeI₂, FeO, Fe₂O₃, FeS, FeCrAl, LaBr₃, LaF₃, PbBr₂, PbCl₂, PbF₂, PbI₂, PbO, PbSnO₃, PbSe, PbS, PbTe, PbTiO₃, LiBr, LiCl, LiF, LiI, Li₂O, MgBr₂, MgCl₂, MgF₂, MgI₂, MnBr₂, MnCl₂, Mn₃O₄, MnS, HgS, MoS₂, MoO₃, NdF₃, Nd₂O₃, NiBr₂, NiCl₂, NiO, NbB₂, NbC, NbN, NbO, Nb₂O₅, NbTex, Nb₃Sn, PdO, C₈H₈, KBr, KCl, KF, KOH, KI, Re₂O₇, RbCl, RbI, SiB₆, SiO₂, SiO, Si₃N₄, SiSe, SiS, SiTe₂, AgBr, AgCl, AgI, AgI, NaBr, NaCl, NaCN, NaF, NaOH, MgO₃, SrF₂, S₈, TaS₂, PTFE,TbF₃, Tb₄O₇, TlBr, TlCl, TlI, Tl₂O₃, ThBr₄, ThF₄, ThOF₂, ThS₂, Tm₂O₃, SnO₂, SnSe, SnS, SnTe, TiO₂, WTe₃, WO₃, UF₄, U₃O₈, UP₂, U₂S₃, V₂O₅, VSi₂, YbF₃Yb₂O₃, YF₃, Zn₃Sb₂, ZnBr₂, ZnF₂, Zn₃N₂, ZnSe, and ZrSi₂.

In particular embodiments, the system is operated in a vacuum. The vacuum pressure can be any pressure that allows for a sufficient purity of the evaporated material relevant to the purpose. In particular environments, the vacuum environment provides a pressure range of from about 10⁻³ to about 10⁻¹⁰ torr. In some embodiments, the vacuum source provides a pressure range of from about 10⁻⁶ to about 10⁻⁹ torr. In certain embodiments, the vacuum source provides a pressure range of from about 10⁻³ to about 10⁻⁶ torr. In particular embodiments, the vacuum source is a deep Ultra High Vacuum source that provides a pressure that is below about 1×10⁻¹⁰ torr.

In one embodiment, the system contains an inert gas. In specific embodiments, the pressure in the system is between about 100 torr and about 10⁻³ torr. Non-limiting examples of inert gases include nitrogen, helium, neon, argon, krypton, xenon, radon, and mixtures thereof.

In one embodiment, the system further comprises a thermal shield surrounding the components of the system. In certain embodiments, the thermal shield can be made of a refractory material. In particular embodiments, the thermal shield can be made of metal.

In another embodiment, two glassy carbon heaters can be used. In one embodiment, the two glassy carbon heaters can be disposed about opposing ends of the electrical contacts, and the electrical contacts can be aligned perpendicular to the length of the filaments. In a particular embodiment, a holding element, e.g., container, for holding the sample can be disposed between the filaments and secured at opposing ends proximate to the thin metal strips of the filaments.

The glassy carbon heater can be attached to the holding element as described in detail by Pfeiffer et al. in U.S. Pat. No. 7,329,595 (incorporated herein by reference in its entirety) with a metal screw and a washer. In particular embodiments, the glassy carbon heater is adapted to engage with at least two electrical contacts at or near two ends of the glassy carbon heater. In one embodiment, the glassy carbon heater is provided with apertures and engaged with at least two electrical contacts via one or more connectors. The connectors can be made of any low vapor, highly temperature stable conducting material.

In some embodiments, the sample is held in a holding element which is located in such proximity to the glassy carbon heater so as to receive heat generated by the glassy carbon heater to heat or evaporate the sample. In specific embodiments, the holding element is in good thermal communication with the glassy carbon heater. In specific embodiments, the holding element is in close contact with the glassy carbon heater or separated by a small gap of 1 mm or less. In another embodiment, the sample is held in place using, for example, fasteners or clamps or another holding element.

The holding element can be any size and any shape that is adapted to hold a sample for evaporation. In particular embodiments, the holding element is a container in the shape of a bowl, sphere, cylinder, box, cone, tetrahedron, circle, oval, rectangle, square, triangle, ellipsis, or polygon. In one embodiment, the container is a bowl-shaped basket. In particular embodiments, the container is a crucible. In certain embodiments, the holding element has one or more grooves, slots, slits, indentations, recesses, holes, or pockets suitable for holding a sample. In one embodiment, the holding element is a clamp.

In particular embodiments, the holding element is made of a refractory material. In particular embodiments, the holding element is made of a refractory conductive material coated with a non-conducting refractory material. In certain embodiments, the holding element is made of a material selected from the group consisting of tantalum, molybdenum, tungsten, beryllium oxide, glassy carbon, Al₂O₃, pyrolytic boron oxide, quartz, sapphire, titanium-carbide, thorium dioxide, and ceramic. In one embodiment, the holding element is permanently fixed to the filament. In another embodiment, the holding element is not permanently attached to the system and can be removed and exchanged without the need for tools.

In certain embodiments, the current applied to the electrical contact is less than about 100 A. In certain embodiments, the current applied to the electrical contact is less than about 80 A, less than about 60 A, less than about 40 A, less than about 20 A, less than about 10 A, or less than about 5 A. In an exemplary embodiment, the current is about 10 A to about 20 A. In certain embodiments, the current applied to the electrical contact is between about 25 A and about 250 A.

In one embodiment, the current applied to the electrical contact is between about 25 A and about 100 A. In particular embodiments, the current applied to the electrical contact is between about 100 A and about 250 A.

In particular embodiments, the voltage applied to the system is less than or equal to about 5 volts. In specific embodiments, the voltage applied to the system is less than or equal to about 4 volts. In one embodiment, the voltage applied to the system is between about 5 volts and about 50 volts. In some embodiments, the voltage applied to the system is between about 0.5 volts and about 10 volts. In other embodiments, the voltage applied to the system is between about 10 volts and about 25 volts. These current and volt values are exemplary. The system can be scaled up or down to any size. For a certain cross section dimensions of a glassy carbon filament, to achieve the same temperature a larger filament will require higher voltage values, and a smaller filament will require lower voltage values.

In particular embodiments, the system further comprises a substrate in proximity to the sample, e.g., in any orientation that allows for the sample to be deposited onto the substrate during evaporation. In some embodiments, the evaporated sample is deposited onto the substrate. In particular embodiments, the evaporated sample can form one or more layers or films on the substrate. The substrate can be any material, device, or apparatus that is able to withstand the pressure and temperature generated in the system.

In particular embodiments, the substrate is a dielectric substrate. Non-limiting examples of dielectric substrates include glass, sapphire, mica, silicon dioxide, silicon nitride, silicon oxy-nitride, aluminum oxide, silicon carbide nitride, organo-silicate glass (OSG), carbon-doped silicon oxides (SiCO or CDO) or methylsilsesquioxane (MSQ), porous OSG (p-OSG).

In one embodiment, the substrate is a semiconducting substrate. Non-limiting examples of semiconducting substrates include silicon, such as silicon carbide, zinc selenide, gallium arsenide, gallium nitride, cadmium telluride or mercury cadmium telluride. In other embodiments, the substrate may include quartz, amorphous silicon dioxide, aluminum oxide, lithium niobate or other insulating material. The substrate may include layers of dielectric material or conductive material over the semiconductor material. In particular embodiments, the substrate is pretreated in order to enhance its ability to receive evaporated sample. Some non-limiting examples of pre-treatments are ultrasonic cleaning in organic solvents as acetone, methanol, and isopropanol.

The methods and systems of the invention can be utilized for the manufacture of any product currently produced using known heating or evaporation methods, including, for example, thermal evaporation or e-beam evaporation. Some non-limiting examples are: optical mirrors, anti-reflecting coatings in optics, and metal contacts in microelectronics industry.

### EXAMPLES

### Example 1

### Glassy Carbon Heater

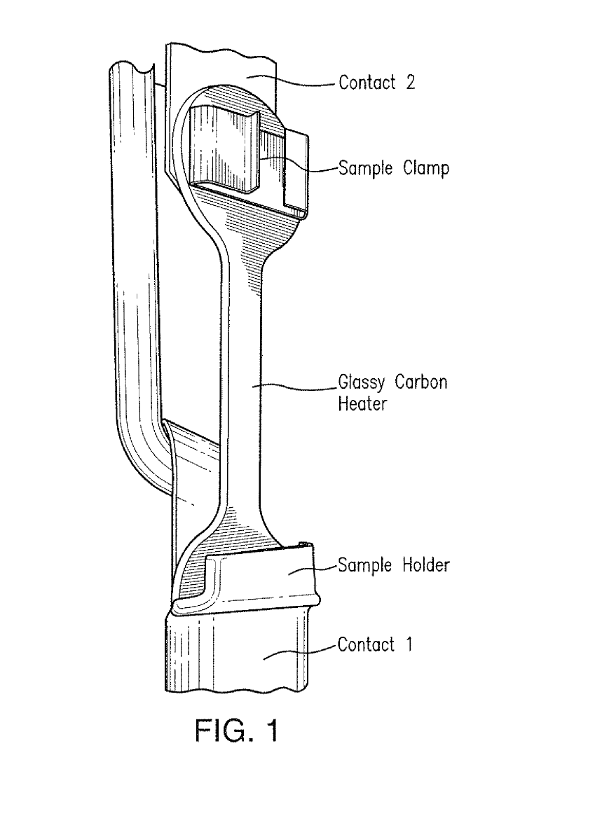

METHODS/MATERIALS: FIG. 1 shows an image of an exemplary system employed to heat a sample. In FIG. 1, the sample is not mounted and the heater element is off. The glassy carbon heater is black. The system has a holding element in the lower part to hold the sample and an upper sample clamp to fix in place the sample in close proximity to the glassy carbon heater.

A piece of glassy carbon was firmly contacted between two leads made of tantalum, a refractory metal. The glassy carbon was obtained from HTW Hochtemperatur-Werkstoffe GmbH (Thierhaupten, Germany) in the shape of 100×100×0.5 mm³ plates and laser-cut by Accu-Tech (550 S. Pacific Street Suite A 100, San Marcos, Calif. 92078) into a dog bone shape. The glassy carbon heater is shown in FIG. 5. A silicon dioxide sample was placed into the sample holder and clamped to be in close proximity to the glassy carbon heater. The sample holder is made out of tantalum. The distance between the glassy carbon heater and the sample is about 0.1 mm to 0.5 mm.

The system was placed under a vacuum of 1×10⁻⁹ torr. A 2.5 voltage was applied to the contacts so that a 3.5 A current was produced from contact 1 to contact 2, which heated the heating element to a temperature of about 1,400° C.

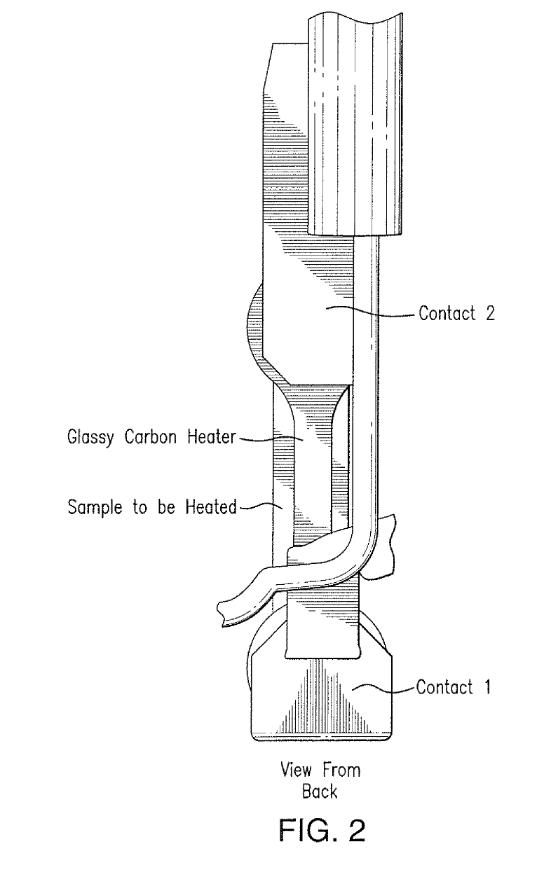

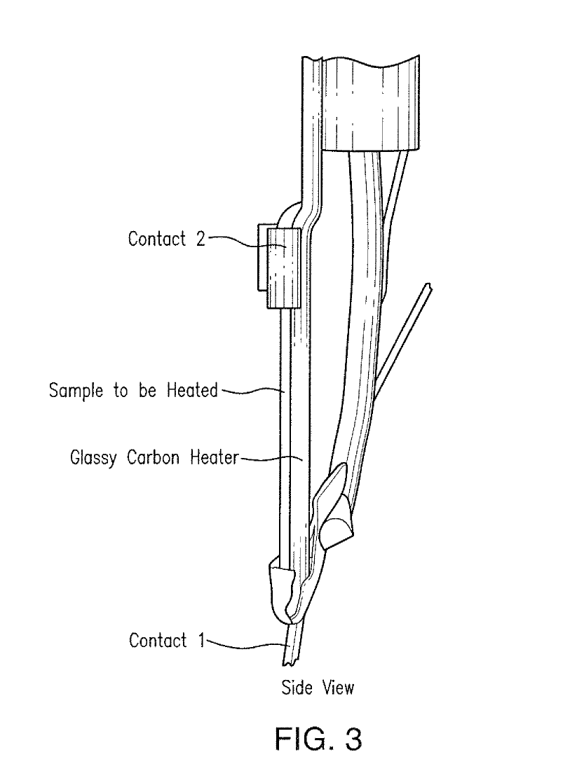

FIG. 2 shows the back view and FIG. 3 shows the front view of the heating system while the sample was being heated. The heat produced caused the heating element to glow bright yellow due to the joule effect. The sample is shown in FIGS. 2 and 3.

DISCUSSION: This experiment demonstrates that a glassy carbon filament can be employed as a heater using a simple, compact, and non-expensive configuration in which very moderate currents of 10-20 A and very safe voltage values of 3-4 V are used.

### Example 2

### Deposition of Copper Via Enhanced Thermal Evaporation

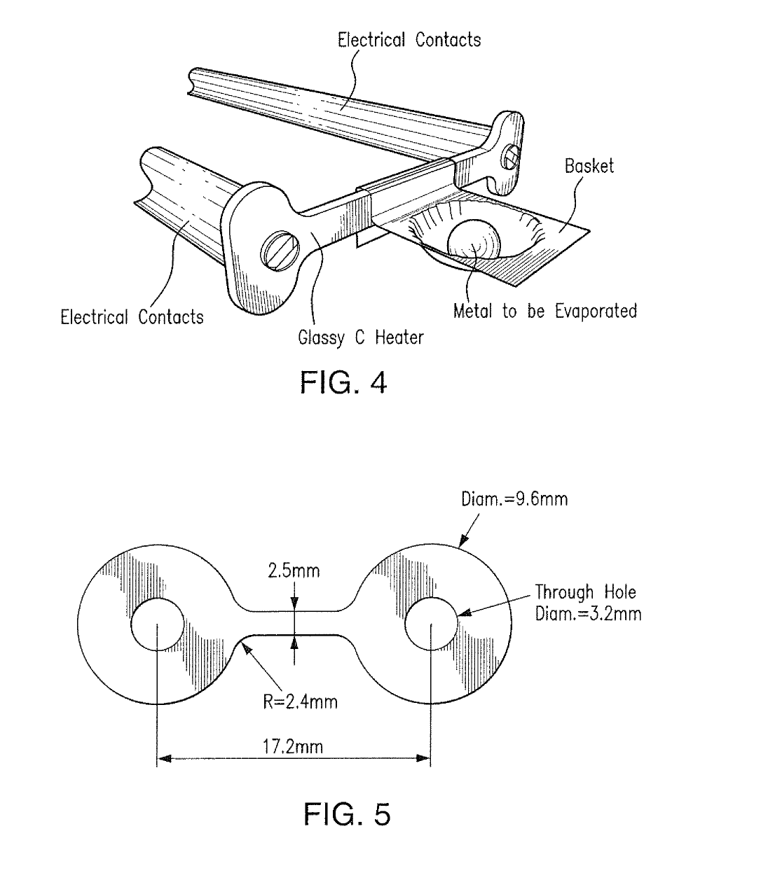

METHODS/MATERIALS: FIG. 4 shows a schematic diagram of the system employed to thermally evaporate copper. The glassy carbon was obtained from HTW Hochtemperatur-Werkstoffe GmbH (Thierhaupten, Germany) in the shape of 100×100×0.5 mm³ plates and laser-cut by Accu-Tech (550 S. Pacific Street Suite A100, San Marcos, Calif. 92078) into a dog bone shape. The glassy carbon heater is shown in FIG. 5. The ring-shaped ends of the glassy carbon heater have an outer diameter of 9.6 mm and an inner diameter of 3.2 mm. The ring-shaped ends of the glassy carbon heater are spaced apart at a center-to-center distance of 17.2 mm and are connected by an integrally-formed thin metal strip having a width of 2.5 mm. Two concavities are formed, one each where each ring-shaped end connects with the thin strip, and each concavity has an arc of radius 2.4 mm. Two electrical contacts, shown in FIG. 4, are disposed within holes in the ring-shaped ends of the glassy carbon heater, one contact per hole, and are held securely therein.

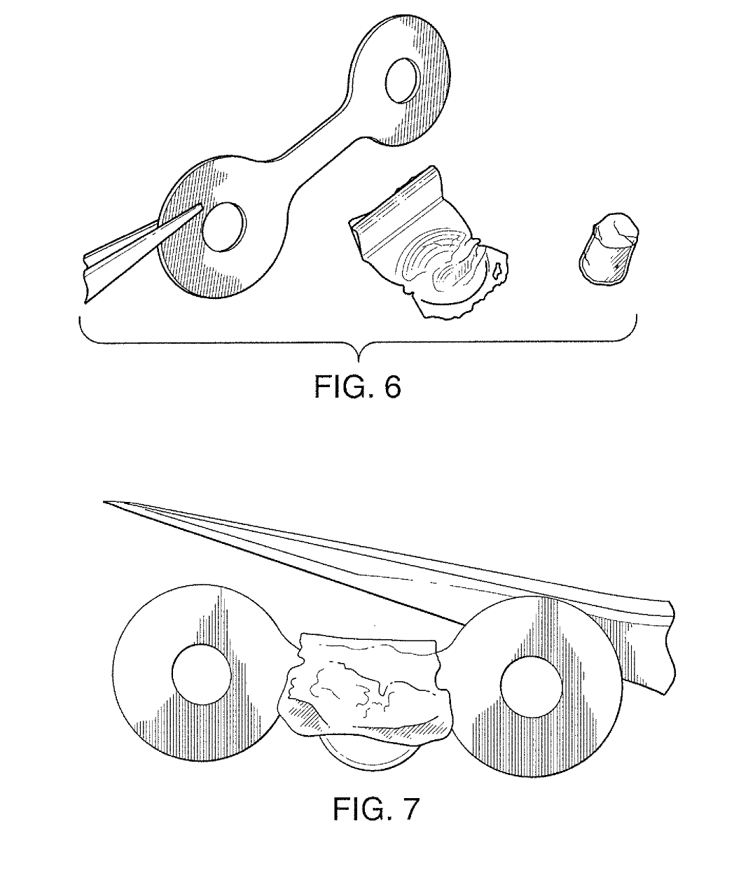

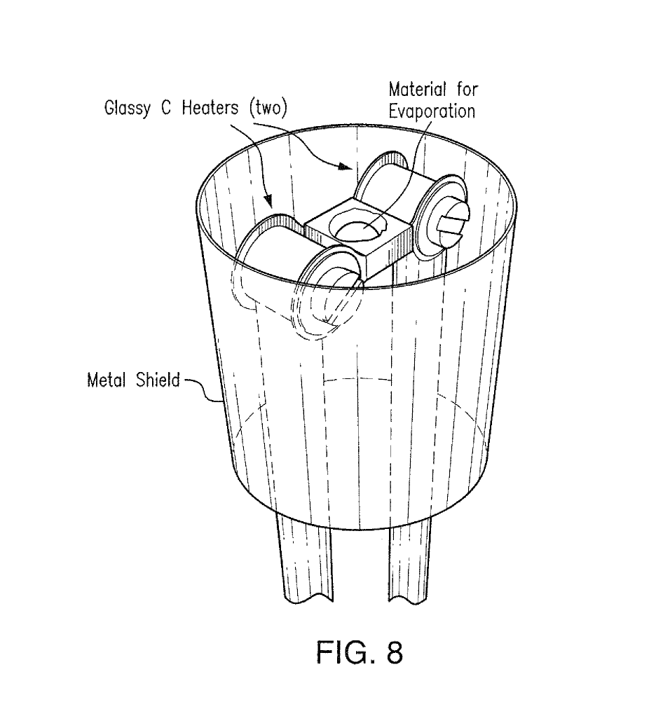

The glassy carbon heater was firmly held to the leads, which were made of tantalum rods with dimensions of/inch in diameter, by tantalum screws. Two rhenium washers sandwich the glassy carbon heater. The electrical feedthrough is made of ¼ inch diameter copper that is screwed into a taped hole machined in the 4 inch diameter tantalum rod. The ends furthest from the glassy carbon heater are made out of copper. The plates were laser-cut by a company located in California called Accu-Tech (550 S. Pacific Street Suite A100, San Marcos, Calif. 92078, Phone (760) 744-6692, Fax (760) 744-4963) into the design of a dog bone shaped filament as depicted in FIG. 5. FIG. 6 shows some unassembled components of the system of FIG. 4 before the copper evaporation process. The electrical contacts (not shown) were inserted into the through holes in the ring-shaped ends of the glassy carbon heater. The basket, which was connected to and heated by the glassy carbon heater and which held the material to be evaporated, is shown. The copper sample that was evaporated is also shown.

The copper sample to be evaporated was placed in the bowl-shaped crucible, or basket, that hung from the glassy carbon heater. The sample, crucible, and filament were placed under vacuum at a pressure of 10⁻⁸ torr. The glassy carbon heater was heated to about 1500° C. by the Joule effect of a current of 14.3 A produced at 3.22 V for 5 minutes. Due to the close proximity of the basket to the heated glassy carbon heater, the basket was annealed to about 1000° C. providing growth rates of 1.7 Å/sec at a distance of 178 mm. Two grams of copper can provide a thickness of 1200 Å at a distance of 178 mm in approximately 11.7 minutes. The growth rate can be accurately controlled from 0.1 to 2 Å/sec by driving a controlled amount of current (from 10 A to 15.6 A) through the glassy carbon heater.

RESULTS: FIG. 7 shows the components of FIG. 6 after the evaporation process. The basket is connected to the glassy carbon heater, and the electrical contacts (not shown) have been removed from the glassy carbon heater. As shown in FIG. 7, the copper has evaporated and solidified on top of the crucible.

DISCUSSION: This experiment demonstrated that the system could be used to evaporate copper using a simple, compact, and non-expensive configuration in which very moderate currents of 10-20 A and very safe voltage values of 3-4 V are used. This experiment demonstrated that the system could be employed to evaporate copper using a lower current and a higher voltage than in conventional thermal evaporation. Additionally, this experiment demonstrated that the system could be used to evaporate copper using a much lower voltage than it is used in conventional e-beam evaporation.

A person having ordinary skill in the art will recognize that the particular examples disclosed herein are for illustration purposes only and do not limit the scope of the disclosed subject matter. For example, a person having ordinary skill in the art will recognize that the disclosed systems and methods for heating and enhanced thermal evaporation can be implemented on smaller and larger scales than those disclosed. In some embodiments, the holding element can be enlarged to achieve larger area growths and larger growth rates. In some embodiments, the size of the components can be reduced to implement a miniature evaporator. Moreover, the systems and methods can be used for the heating or evaporation of various samples, and are not limited by those samples exemplified herein.

What is claimed is:

1. A system for heating a sample comprising:
(a) an electrical contact adapted to receive current;
(b) a glassy carbon heater in electrical communication with the electrical contact; and
(c) a sample,
the sample located in such proximity to the glassy carbon heater so as to receive heat generated by the glassy carbon heater.

2. The system of claim 1, wherein the sample is thermally evaporated.

3. The system of claim 1, further comprising a holding element adapted to hold the sample, the holding element located in such proximity to the glassy carbon heater so as to receive heat generated by the glassy carbon heater to heat the sample.

4. The system of claim 1, wherein the sample is selected from zinc, aluminum, germanium, copper, silver, gold, titanium, nickel, platinum, palladium, lithium, beryllium, sodium, magnesium, potassium, calcium, rubidium, strontium, cesium, barium, scandium, yttrium, lanthanum, vanadium, cadmium, mercury, boron, gallium, indium, thallium, silicon, germanium, tin, lead, bismuth, antimony, arsenic, selenium, iron, cobalt, chromium, manganese, lutetium, ytterbium, erbium, dysprosium, europium, cerium, AlF₃, AlN, AlSb, AlAs, AlBr₃, Al₄C₃, Al₂Cu, AlF₃, AlN, Al₂Si, Sb₂Te₃, Sb₂O₃, Sb₂Se₃, Sb₂S₃, As₂Se₃, As₂S₃, As₂Te₃, BaCl₂, BaF₂, BaO, BaTiO₃, BeCl₂, BeF₂, BiF₃, Bi₂O₃, Bi₂Se₃, Bi₂Te₃, Bi₂Ti₂O₇, Bi₂S₃, B₂O₃, B₂S₃, CdSb, Cd₃As₂, CdBr₂, CdCl₂, CdF₂, CdI₂, CdO, CdSe, CdSiO₂, CdS, CdTe, CaF₂, CaO, CaO—SiO₂, CaS, CaTiO₃, CeF₃, CsBr, CsCl, CsF, CsOH, CsI, NasAl₃Fl₄, CrBr₂, CrCl₂, Cr—SiO, CoBr₂, CoCl₂, CuCl, Cu₂O, CuS, Na₃AlF₆, DyF₃, ErF₃, EuF₂, EuS, GaSb, GaAs, GaN, GaP, Ge₃N₂, GeO₂, GeTe, HoF₃, InSb, InAs, In₂O₃, InP, In₂Se₃, In₂S₃, In₂S, In₂Te₃, In₂O₃—SnO₂, FeCl₂, FeI₂, FeO, Fe₂O₃, FeS, FeCrAl, LaBr₃, LaF₃, PbBr₂, PbCl₂, PbF₂, PbI₂, PbO, PbSnO₃, PbSe, PbS, PbTe, PbTiO₃, LiBr, LiCl, LiF, LiI, Li₂O, MgBr₂, MgCl₂, MgF₂, MgI₂, MnBr₂, MnCl₂, Mn₃O₄, MnS, HgS, MoS₂, MoO₃, NdF₃, Nd₂O₃, NiBr₂, NiCl₂, NiO, NbB₂, NbC, NbN, NbO, Nb₂O₅, NbTex, Nb₃Sn, PdO, CsH₈, KBr, KCl, KF, KOH, KI, Re₂O₇, RbCl, RbI, SiB₆, SiO₂, SiO, Si₃N₄, SiSe, SiS, SiTe₂, AgBr, AgCl, AgI, AgI, NaBr, NaCl, NaCN, NaF, NaOH, MgO₃, SrF₂, S₈, TaS₂, PTFE,TbF₃, Tb₄O₇, TlBr, TlCl, TlI, Tl₂O₃, ThBr₄, ThF₄, ThOF₂, ThS₂, Tm₂O₃, SnO₂, SnSe, SnS, SnTe, TiO₂, WTe₃, WO₃, UF₄, U₃O₈, UP₂, U₂S₃, V₂O₅, VSi₂, YbF₃Yb₂O₃, YF₃, Zn₃Sb₂, ZnBr₂, ZnF₂, Zn₃N₂, ZnSe, and ZrSi₂.

5. The system of claim 3, wherein the holding element is made of a refractory material.

6. The system of claim 3, wherein the holding element is made of a material selected from tantalum, molybdenum, tungsten, tungsten carbide, rhenium, ruthenium, iridium, osmium, hafnium, zirconium, zirconium dioxide, niobium, vanadium, chromium, beryllium oxide, glassy carbon, aluminum oxide, boron nitride, oxide, quartz, sapphire, titanium, titanium-carbide, thorium dioxide, and ceramic, hafnium carbide, tantalum hafnium carbide.

7. The system of claim 3, wherein the holding element is a container in the shape of a bowl, sphere, cylinder, box, cone, tetrahedron, circle, oval, rectangle, square, triangle, ellipsis, or polygon.

8. The system of claim 1, wherein the glassy carbon heater has a thickness of from about 5 μm to about 1 cm.

9. The system of claim 1, wherein the glassy carbon heater is adapted to engage with at least two electrical contacts at or near two ends of the glassy carbon heater.

10. The system of claim 1, wherein the glassy carbon heater is provided with apertures and engaged with the at least two electrical contacts via a metal screw and a washer.

11. A method for heating a sample comprising
(a) providing an electrical contact adapted to receive current; a glassy carbon heater in electrical communication with the electrical contact; and a sample, the sample located in such proximity to the glassy carbon heater so as to receive heat generated by the glassy carbon heater and
(b) applying current to the electrical contact to heat the sample.

12. The method of claim 11, wherein the sample is thermally evaporated.

13. The method of claim 11, wherein the glassy carbon heater is heated to a temperature of about 20° C. to about 800° C.

14. The method of claim 11, wherein the glassy carbon heater is heated to a temperature of about 800° C. to about 1,800° C.

15. The method of claim 11, wherein the current applied to the electrical contact is less than about 100 A.

16. The method of claim 11, wherein the current applied to the electrical contact is less than about 25 A.

17. The method of claim 11, wherein the method further comprises providing a pressure of less than about 10⁻³ torr.

18. The method of claim 1, wherein the method further comprises providing a substrate in proximity to the sample.

19. The method of claim 18, wherein the substrate is a dielectric substrate.

20. The method of claim 19, wherein the dielectric substrate is selected from the group consisting of glass, sapphire, mica, silicon dioxide, silicon nitride, silicon oxy-nitride, aluminum oxide, silicon carbide nitride, organo-silicate glass, carbon-doped silicon oxides, or methylsilsesquioxane (MSQ).

21. The method of claim 18, wherein the substrate is a semiconducting substrate.

22. The method of claim 21, wherein semiconducting substrate is selected from the group consisting of silicon, silicon carbide, zinc selenide, gallium arsenide, gallium nitride, cadmium telluride or mercury cadmium telluride.
